(19) United States
(12) Patent Application Publication
(10) Pub. No.: US 2011/0008598 A1
(43) Pub. Date: Jan. 13, 2011

(54) PROTECTIVE PANEL

(75) Inventor: Emo Agneloni, San Mariano (IT)

Correspondence Address: YOUNG & THOMPSON, 209 Madison Street, Suite 500, Alexandria, VA, 22314, US

(73) Assignee: TEC.INN. S.R.L., San Mariano (PG) (IT)

(21) Appl. No.: 12/866,905

(22) PCT Filed: Mar. 11, 2009
(86) PCT No.: PCT/IT2009/000092

§ 371 Date: Aug. 10, 2010

(30) Foreign Application Priority Data
Mar. 12, 2008 (IT) RM2008A000135

(51) Int. Cl. B32B 5/02; B32B 7/12; B32B 18/00; B32B 7/02

(52) U.S. Cl. 428/213; 428/221; 442/1; 428/339

(57) ABSTRACT

A protective panel includes an inner surface (7) proximate to a body to be protected and an outer surface (8) distal from the body. Between the inner and outer surface (7, 8) is housed a multi-layer structure (2) constituted by at least one layer of ceramic material (3) and/or aluminum and at least one layer of fabric (4) with high resistance against perforation, coupled to each other by an adhesive layer (5) made of elastic material.

### TECHNICAL FIELD

The present invention relates to a protective panel, in particular for vehicles of various kinds (e.g. terrestrial, aerial, seaborne vehicles, etc.), construction structures or individual protection covers such as screens, shields and the like. In detail, the present invention relates to a protective panel able to be coupled to the outer surface of a body to be shielded, to protect said body against the impact of a projectile of any calibre, shot by a firearm, and/or against the combined effect of projectiles and explosion (e.g. a rocket or a grenade).

### BACKGROUND ART

Prior art protective panels are constituted by plates made of metallic material, applied on the outer surface to be shielded, e.g. with appropriate adhesive resins, such as epoxy resins.

These plates are generally obtained from superposed layers, preferably made of steel or other, particularly strong composite materials, able to break up the impact of a projectile, preventing it from penetrating through the outer surface of the body to be protected.

Other known panels are manufactured with layers of ceramic material or alumina, constituted by a series of plates placed to abut each other to define a continuous protective surface.

The panels described above normally undergo a series of shaping operations, to make them adaptable to the shape of the surface to be covered.

For example, in the case of armoured vehicles, the plate is shaped, and appropriately adapted, to the area of the outer body of the vehicle to be protected. In this way, the vehicle is covered in all desired parts, in particular in particularly vulnerable areas, e.g. at the tracks of terrestrial vehicles.

The protective panels described above, however, have important drawbacks.

A first drawback is linked to the shaping operations, which are particularly laborious and therefore there are high manufacturing costs for each individual panel. This drawback is given by the structure in itself, which is stiff and particularly strong, and therefore hard to model and deform, which the plate must have in order effectively to stop the impact of the projectile.

Moreover, it should be noted that these panels cannot be used at areas having particular shapes, e.g. the angular areas or any shapes. In this case, the plate cannot be modelled in order effectively to protect surfaces having complex developments.

An additional drawback is given by the excessive weight of such panels which, as described above, are normally manufactured with steel plates.

Consequently, known protective panels cannot be used to reinforce individual protection devices that must be handled by the user, e.g. shields or screens.

Lastly, another drawback of the protective panel described above is that, as a result of the impact of the projectile on a surface, said surface can shatter together with the projectile forming a series of splinters that can accidentally invest areas neighbouring the body to be protected.

### DISCLOSURE OF INVENTION

In this context, the specific technical task of the present invention is to propose a protective panel able to overcome the aforementioned drawbacks.

In particular, an object of the present invention is to make available a protective panel that is easy to apply to any type of surface to protect.

An additional object of the present invention makes available a protective panel that is light and at the same time able to contain any formation of splinters.

The specified technical task and the objects specified are substantially achieved by a protective panel comprising the technical characteristics exposed in one or more of the appended claims.

### DESCRIPTION OF THE DRAWINGS

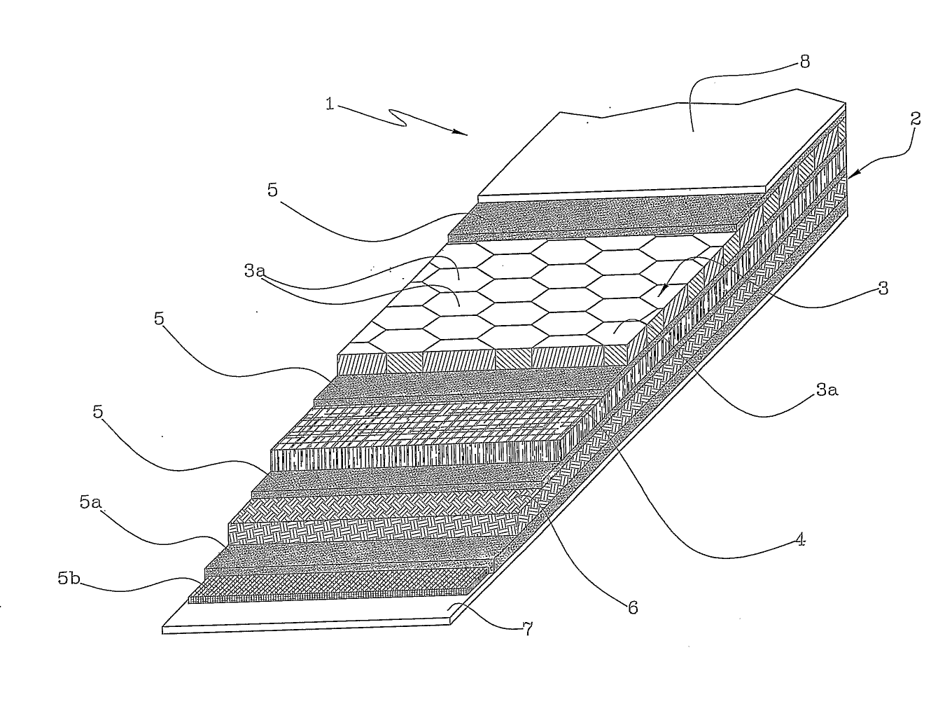

Additional characteristics and advantages of the present invention shall become more readily apparent from the indicative, and therefore not limiting, description of a preferred but not exclusive embodiment of a protective panel, as illustrated in FIG. 1 which shows a perspective and partially sectioned view of a protective panel in accordance with the present invention.

### DESCRIPTION OF THE ILLUSTRATIVE EMBODIMENT

With reference to the accompanying figures, the reference number 1 designates in its entirety a protective panel according to the present invention.

The protective panel 1 finds advantageous use in vehicles of various kinds (terrestrial, seaborne or aerial), in the construction structures, and in individual defence systems such as shields or screens.

However, it must be specified that the protective panel 1 can be used for any application in which there is a requirement to protect a body against the impact of a projectile of various calibres, shot by firearms and/or against the explosion of a device that produces high temperatures and fragments (e.g. a rocket or a grenade).

In detail, the protective panel 1 comprises a multi-layer structure 2 constituted by at least one layer of ceramic material 3 coupled to at least one layer made of high-strength fabric 4.

In greater detail, as is better illustrated in FIG. 1, the layer of ceramic material 3 is constituted by a plurality of rigid plates 3a of adequate shape and dimensions, abutting each other to define a continuous protective surface.

The plates 3a are advantageously made of alumina and they have substantially polygonal, preferably hexagonal peripheral development. As FIG. 1 clearly shows, the plates 3a are mutually adjacent and joined in mosaic fashion to be able to adapt to the surface to be coated.

The layer of ceramic material 3, which is the outermost layer with respect to the body to be protected, is able to disarticulate the projectile that hits the individual plates 3a and to protect the body to be coated against high temperatures.

The fabric layer 4 is coupled to the layer of ceramic material 3 by means of an adhesive layer 5 made of elastic material, which will be better described below. Said fabric layer 4, which is positioned between the body to be protected and the ceramic material layer 3, is poorly deformable and it is constituted by a metal mesh, preferably made of steel, with extremely close and crossed weft, if necessary, on multiple superposed layers. The fabric layer 4 is particularly resistant in view of its mesh structure and it is able to contain both the projectile and any splinters of the alumina plates 3a of the ceramic material layer 3 resisting and calling to collaborate the region surrounding the area hit by the projectile.

Moreover, the multi-layer structure 2 presents a layer made of deformable material 6 made of aramidic material and interposed between the fabric layer 4 and the body to be protected.

The layer of deformable material 6 is anchored to the fabric layer 4 by means of an additional adhesive layer 5 made of elastic material, and constitutes and additional barrier both to the projectile and any fragments of alumina and of structure.

This layer made of deformable material 6 is advantageously constituted by a series of panels, mutually abutted or, alternatively, by a fabric made of aramidic fibres arranged in a tight mesh. Note that the layer 6 has an elastic module having higher deformability (e.g., with respect to the steel fabric) the better progressively to dissipate and effectively to absorb the energy of the impact caused by the projectile.

Moreover, the layer of deformable material 6 has, at a respective surface proximate to the body to be protected, an adhesive layer 5a made of elastic material preferably having greater thickness than the thickness of the other adhesive layers 5.

Said adhesive layer 5a proximate to the body to be protected preferably has thickness between 0.5 and 2 cm to allow deformation, adequate with respect to the specific and general requirements, to be able to absorb and contain any fragments of projectile and of the previous layers, dissipating residual energy.

Additionally, the adhesive layer 5a can be added with high hardness material, e.g. alumina powder to increase the mechanical strength of the layer 5a itself and reinforced with traction-resistant material 5b but with relatively low elastic module, e.g. glass fibre, to allow low, medium or high deformations (always greatly exceeding those of the other previous layers).

Moreover, the layers 5 and 5a can be partially uncoupled through chemical disarming compounds, physical films, etc. (release agent). In this way, the layers 5, 5a are split in two maintaining the respective original characteristics, to be able to improve the overall response of the structure 2, which can have greater and better distributed dissipative deformations, under particular events.

The partial uncoupling of the layers 5 and 5a takes place, e.g., achieving regular geometric shapes (squares, rectangles, etc . . . ) defining an alternating chessboard of empty areas uncoupled through the aforementioned disarming chemical agent, with full areas in which polyurea is in chemical, physical and mechanical continuity.

The size of the empty and filled areas is determined according to the shape and dimensions of the body to be protected, and according to the expected characteristics of the external phenomenon against which the body is to be protected to have an appropriate and advantageous distribution of said areas.

The multi-layer structure 2 thus constituted can be manufactured with different dimensions according to the type of protection to be obtained. For example, each individual layer can have variable thickness and a higher number of layers than the one described above can be provided. Additionally, the mesh of the fabric layer 4 and the mesh of the deformable material layer 6 can be wider or narrower based on the type of projectile or complex effect (projectile, shock wave and temperature) to be contained.

Advantageously, the multilayer structure 2 is anchored and closed in a “packet” between an inner surface 7 and an outer surface 8.

As shown in FIG. 1, the inner surface 7 is proximate and able to be associated to the body to be protected whilst the outer surface 8 and distal from the aforementioned body.

Note that the layer of ceramic material 3 is coupled to the outer surface 8 by means of an additional adhesive layer 5 made of elastic material.

Advantageously, the inner surface 7 is coupled to the layer of deformable material 6 through the aforesaid adhesive layer 5a having increased thickness.

The surfaces 7, 8 can be made of any material and thickness according to the type of body to be protected.

The adhesive layers 5, 5a of elastic material are preferably made of polyurea with high tenacity and low modulus of elasticity.

In greater detail, the adhesive layers 5, 5a are made of polyurea, preferably by means of a process of direct spraying of the polyurea itself on the respective layers to be coupled.

In this way, when polyurea is sprayed onto the layers constituted by mesh fabrics (fabric layer 4 and deformable material layer 6), the polyurea itself envelops the filaments so that, once the polyurea hardens, said filaments remain irreversibly and permanently associated to the adhesive layers 5, 5a obtained with the polyurea itself.

To cover any surface of the body to be covered, the protective panel 1 described above is set onto the surface itself through the process of spraying the polyurea that reaches the surface in the liquid state, perfectly adapting to the shape even in individual points, and solidifies in very limited times (even a few seconds), making it advantageously adhere to the surface.

It should be noted that the particularly structure of the panel 1 allows it to have good adaptability, irrespective of the shape of the surface of the body to be protected.

Alternatively, the various layers described above are laid in sequence directly onto the surface of the body.

In this case, it should be noted that both the layer of deformable material 6 and the fabric layer 4 and foldable (deformable) also because they are made of mesh. Moreover, as described above, the adhesive layers 5, 5a are sprayed directly onto the respective layers in such a way as to shape said adhesive layers 5, 5a directly to the particular shape of the surface to be covered.

Moreover, the ceramic material layer 3 is also foldable because the plates 3a, which abut each other and are not mutually fastened, can be oriented according to the planar development of the surface of the body to be covered.

The present invention therefore achieves the proposed objects, overcoming the drawbacks noted in the prior art.

The manufacture of a particularly flexible protective panel 1 enables to cover any type of surface of the body to be protected, irrespective of their development.

Advantageously, as described above, the panel 1 can be manufactured directly on said surface to be covered, sequentially laying one layer over the other starting from the one closest to the body to be protected. In relation to the use of polyurea, among its advantages to be highlighted are its very short setting time (a few seconds for it to harden) and its ease of application, which can be accomplished by simple spraying (in pressure and temperature).

Advantageously, the protective panel 1 does not have to undergo any additional shaping operations with the consequent advantages in terms of production times and costs.

Moreover, the structure of the panel is particularly light, given the presence of polyurethane layers and metal mesh structures. Therefore, the protective panel 1 can also be used in personal covering devices, e.g. shields or clothing issued to law enforcement agencies, with appropriate adaptations.

It should also be noted that the presence of a multi-layer structure determines a progressive resisting action against the impacts of the projectile, providing an effective action of ballistic protection and considerable dissipation of energy. This characteristic is given by the presence of layers having differentiated characteristics of deformability and strength. Moreover, the adhesive layers 5, 5a determine (in combination with the layers 4 and 6) a dissipative action able to contain the projectile absorbing its impact energy and preserving the body to be protected.

Lastly, an additional advantage is given by the mesh structure made of metallic and aramidic fibres of the layers 4 and 6, which contain any splinters or sharp fragments that are generated consequently to the impact of the projectile on the ceramic plates 3a and/or to the impact/explosion on the structure to be protected.

1. Protective panel, characterised in that it comprises:
an inner surface (7) proximate to a body to be protected and an outer surface (8) distal from said body;
a multi-layer structure (2) interposed between said inner and outer surface (7, 8), said multi-layer structure (2) comprising at least one layer of ceramic material (3) and at least one layer of high-strength fabric (4), mutually coupled by means of an adhesive layer (5) made of elastic material.

2. Panel as claimed in claim 1, characterised in that said layer of ceramic material (3) comprises a plurality of rigid plates (3a), abutting each other to define a continuous surface; said plates (3a) being made of alumina.

3. Panel as claimed in claim 1, characterised in that said layer of ceramic material (3) is coupled to said outer surface (8) by means of an adhesive layer (5) made of elastic material.

4. Panel as claimed in claim 1, characterised in that said fabric layer (4) comprises a metal mesh.

5. Panel as claimed in claim 1, characterised in that it further comprises a layer of deformable material (6) made of aramidic material; said layer of deformable material (6) being interposed between said fabric layer (4) and said inner surface (7).

6. Panel as claimed in claim 6, characterised in that said layer of deformable material (6) is constituted by a plurality of panels.

7. Panel as claimed in claim 5, characterised in that said layer of deformable material (5) is constituted by a fabric of aramidic fibres.

8. Panel as claimed in claim 5, characterised in that said layer of deformable material (6) is coupled to said fabric layer (4) and to said inner surface (7) by means of respective adhesive layers (5) made of elastic material.

9. Panel as claimed in claim 8, characterised in that said adhesive layer (5a) made of elastic material interposed between the inner surface (7) and the layer of deformable material (6) has greater thickness than the other adhesive layers (5).

10. Panel as claimed in claim 8, characterised in that said adhesive layer (5a) made of elastic material interposed between the inner surface (7) and the layer of deformable material (6) has thickness between 0.5 and 2 cm.

11. Panel as claimed in claim 1, characterised in that said adhesive layer (5, 5a) made of elastic material is made of polyurethane material with high strength and low modulus of elasticity.

12. Panel as claimed in claim 8, characterised in that said adhesive layer (5a) made of elastic material interposed between the inner surface (7) and the layer of deformable material (6) comprises a material with high hardness, preferably constituted by alumina powder.

13. Panel as claimed in claim 1, characterised in that said adhesive layer (5, 5a) is reinforced with a traction-resistant material (5b).

14. Panel as claimed in claim 13, characterised in that said traction-resistant material (5b) comprises glass fibres.

15. Panel as claimed in claim 2, characterised in that said layer of ceramic material (3) is coupled to said outer surface (8) by means of an adhesive layer (5) made of elastic material.

16. Panel as claimed in claim 6, characterised in that said layer of deformable material (6) is coupled to said fabric layer (4) and to said inner surface (7) by means of respective adhesive layers (5) made of elastic material.

17. Panel as claimed in claim 7, characterised in that said layer of deformable material (6) is coupled to said fabric layer (4) and to said inner surface (7) by means of respective adhesive layers (5) made of elastic material.

18. Panel as claimed in claim 9, characterised in that said adhesive layer (5a) made of elastic material interposed between the inner surface (7) and the layer of deformable material (6) has thickness between 0.5 and 2 cm.
